(19) United States
(12) Patent Application Publication
(10) Pub. No.: US 2009/0024413 A1
(43) Pub. Date: Jan. 22, 2009

(54) METHOD AND SYSTEM TO MANAGE CROSS INSTITUTIONAL MAMMA CARCINOMA CARE PLANS

(76) Inventors: Sultan Haider, Erlangen (DE); Volker Schmidt, Elsterweg (DE); David Wolfgng Eberhard Schmidt, Erlangen (DE); Dominic Pascal Schmidt, Erlangen (DE)

Correspondence Address: BRINKS HOFER GILSON & LIONE, P.O. BOX 10395, CHICAGO, IL, 60610, US

(21) Appl. No.: 11/780,186

(22) Filed: Jul. 19, 2007

(51) Int. Cl. G06Q 50/00; G06Q 10/00

(52) U.S. Cl. 705/3

(57) ABSTRACT

A system and method dynamically update the status of a care plan to be performed at different locations. Worksteps of the care plan may be performed at a number dispersed medical facilities and/or specialists. Data regarding a workstep may be locally entered at the facility that performs the workstep. A virtual representation of the care plan may then be updated, and subsequently remotely accessed via a communications network by other medical facilities to view the current status of the care plan. For instance, before a current workstep is performed, medical personnel may view textual information detailing and images acquired during the performance of a previous workstep performed at a different facility. As a result, an effective and efficient means of transferring information regarding the patient and care plan among medical facilities is provided. Additionally, the performance of each medical facility and individual specialist may be evaluated and the results displayed.

### BACKGROUND

The present embodiments relate generally to the improvement of medical treatment. More particularly, the present embodiments relate to enhancing cross institutional medical treatment and workflows.

Conventional medical care plans may be administered to a patient in a series of steps, with individual steps being performed at different medical facilities and/or by different specialists located at dispersed locations. However, the flow of information regarding the patient and the care plan between the different medical facilities and/or personnel may be incomplete and/or inefficient. For instance, each different facility may maintain its own medical records and/or database, which other facilities may not have access to. Additionally, the treatment administered at one facility may be unbeknownst to other facilities. As a result, confusion may result between the medical personnel treating the patient at different locations, and unnecessary or redundant medical treatment may be performed. Further, conventional techniques may have no means for tracking the quality of performance of specific medical personnel and/or facilities.

As an example, conventional methods of treating breast cancer may exhibit the above limitations. The chance that breast cancer will be responsible for a woman's death is currently about 1 in 33 (3%). The World Health Organization estimates that 1.2 million women will be diagnosed with breast cancer each year worldwide. In 2007, the American Cancer Society calculates that approximately 180,000 new U.S. cases of breast cancer will be diagnosed. It is further estimated that breast cancer will cause the death of approximately 41,000 American women in 2007. Accordingly, women aged over forty are typically recommended to be screened for breast cancer once a year.

However, conventional workflows and software applications related to the detection and treatment of breast cancer may have limitations. The limitations may be associated with the inefficient sharing of information, such as information regarding the status of the patient and the healthcare that the patient has previously received to treat the breast cancer, between medical personnel and/or facilities.

### BRIEF SUMMARY

A system and method may dynamically maintain a care plan of a patient, or a virtual representation thereof, up-to-date. A number of medical facilities may be interconnected via a communications network, such as the Internet, that permits the transfer of information among and between the medical facilities. Each time a workstep within the care plan is performed at one of the medical facilities, information regarding the care administered to the patient may be entered at that medical facility via a user interface to remotely update a database and/or a virtual overview associated with the care plan. When the next workstep within the care plan is to be performed at a subsequent medical facility, medical personnel at that facility may remotely access and display a virtual representation of the up-to-date care plan. As a result, the medical personnel at the subsequent medical facility may efficiently learn what care was administered to the patient at other medical facilities during previously performed worksteps within the care plan. Evaluations regarding the quality of care provided by individual facilities and specialists may be automatically performed and the results presented. In one embodiment, the care plan involves a workflow assisted by one or more interactive software applications and/or acquiring internal medical images of the patient via medical imaging devices.

In one aspect, a method facilitates cross institutional healthcare. The method includes dynamically maintaining a virtual representation of an overview of a care plan for a patient up-to-date by integrating medical information regarding individual worksteps associated with the care plan via a processor, the individual worksteps being performed among a plurality of medical facilities. The method also includes providing remote access to data associated with the virtual representation of the overview of the care plan over a communications network such that the virtual representation may be reproduced to display a current status of the care plan at a remote location.

In another aspect, a method facilitates cross institutional healthcare. The method includes dynamically updating a virtual representation of a care plan for a patient using workstep data associated with a performance of a workstep within the care plan at a first medical institution. The method also includes providing remote access to data via a communications network associated with the dynamically updated virtual representation of the care plan such that the dynamically updated virtual representation may be reproduced at a second medical institution to display information regarding the performance of the workstep within the care plan performed at the first medical institution.

In another aspect, a data processing system facilitates cross institutional healthcare. The system includes a data processor operable to (1) remotely receive data from a plurality of medical facilities regarding a single care plan for a patient over a communications network, the single care plan comprising a plurality of worksteps to be performed among the plurality of medical facilities; (2) dynamically maintain the current status of the care plan for the patient up-to-date using the data received; and (3) provide remote access to a machine readable representation of the up-to-date care plan over the communications network such that each of the plurality of medical facilities may locally reproduce the machine readable representation of the up-to-date care plan.

In yet another aspect, a computer-readable medium provides instructions executable on a computer. The instructions direct dynamically updating a virtual representation of a care plan for a patient using first workstep data regarding the performance of a first workstep associated with the care plan at a first medical facility. The instructions also include providing remote access to the dynamically updated virtual representation of the care plan such that the dynamically updated virtual representation of the care plan may be reproduced to display a current status of the care plan at a second medical facility.

Advantages will become more apparent to those skilled in the art from the following description of the preferred embodiments which have been shown and described by way of illustration. As will be realized, the system and method are capable of other and different embodiments, and their details are capable of modification in various respects. Accordingly, the drawings and description are to be regarded as illustrative in nature and not as restrictive.

### BRIEF DESCRIPTION OF THE DRAWINGS

FIG. 1 illustrates an exemplary technique of dynamically updating a medical care plan;

FIG. 2 illustrates an exemplary interconnected network;

FIG. 3 illustrates an exemplary user interface for dynamically maintaining a medical care plan up-to-date and sharing information among medical institutions performing a single care plan;

FIG. 4 illustrates an exemplary screen of the user interface associated with FIG. 3;

FIGS. 5 and 6 illustrate other exemplary user interface screens; and

FIG. 7 illustrates an exemplary data processor configured or adapted to provide the functionality for dynamically maintaining an overview of a medical care plan and workstep information associated with the performance of the medical care plan up-to-date.

### DETAILED DESCRIPTION

The embodiments described herein include methods, processes, apparatuses, instructions, systems, or business concepts for dynamically maintaining a medical care plan for a patient up-to-date. The care plan may be administered via a number of medical facilities and/or medical personnel, such as specialists, located at dispersed locations. After a workstep within the care plan is administered at one medical facility, the care plan may be dynamically updated. For instance, data regarding the status of and/or details regarding the results of the workstep performed, as well as other patient information may be entered by medical personal located at that medical facility via a user interface.

The data entered may be used update, via a processor, a virtual representation of the care plan stored in either a local or a remote database accessible over a communications network. Other medical facilities that perform subsequent worksteps within the care plan may then remotely access and locally display the updated virtual representation of the care plan to ascertain the current status of the patient/care plan, such as before performing the next or other subsequent workstep within the care plan. Patient appointments also may be scheduled and tracked via a user interface associated with the virtual representation of the care plan.

The present embodiments may provide a system/software application operable to present a complete overview of a patient's care path that is to be performed among a number of healthcare institutions and/or specialists. The software application may include a user interface that implements access rights or other security measures. The user interface may provide user management of one facility with access to data associated with the care plan collected at other facilities.

The term “care plan” as used herein refers to a medical workflow that includes a number of worksteps associated with the diagnosis and/or treatment of an illness. For example, typical worksteps within a care plan may include screening, diagnostic testing, therapy, demonstrations, physical examinations, individual therapy, operations, ambulance care, out-patient care, in-patient care, oncology related care, and other steps.

Statistical evaluation of the medical data associated with one or more worksteps and/or care plans performed on a number of patients may be calculated via a processor. In one aspect, an evaluation may be detail on how well individual medical professionals and/or sites are performing. The evaluation may detail and/or rank the quality of performance of medical facilities and specialists available within a given region. As a result, the quality of medical service for patients within the given region may be determined and presented to dispersed customers. Medical facilities in need of a specialist or another medical facilities' expertise may be readily able to determine the most qualified specialists or medical facilities in a particular field. Likewise, patients may be able to assess the relative strengths and weaknesses of various facilities and specialists before making a medical care decision.

In one embodiment, the care plan may provide for the treatment of breast cancer and/or mamma carcinoma among a number of medical facilities/specialists. In general, the mamma carcinoma associated with breast cancer is a malign tumor and caused by a gene modification of the breast tissue. In the western world, every 10^{th} woman gets breast cancer and it is the most frequent cause of death of women between the age of thirty and sixty. However, early diagnosis provides a good chance to successfully treat breast cancer.

The exact causes of the breast cancer are not known. All women over the age of forty should have a mammogram (radiological breast screening) every year. Breast cancer related care plans may be multi-disciplinary plans in order to provide for the best clinical care. Accordingly, the present embodiments facilitate the efficient treatment of breast cancer among a number of medical facilities and/or specialists. However, the care plans discussed herein include generic elements that may be adapted to other types of medical care plans and illnesses.

Within the mamma carcinoma care path solution of the present embodiments, a medical professional may be allowed to work within a certain area within the care plan and be presented with the relevant data associated with that area. The present solution may include presenting (1) the cost of a single step within a treatment workflow (which may support a new financing model); (2) who (i.e., medical facility and/or specialist) is allowed to perform a single step within the care plan (which may be a tool for user management); (3) pre-selections and/or pre-configurations associated with a specific medical professional and/or institution (such as automatically saved settings for medical equipment and software applications); and (4) who (i.e., medical facility and/or specialist) previously performed a workstep and when (which may be a tool for monitoring and evaluation). The present solution may include (5) automatically creating a link within data stored as a medical record/file (such that workstep data stored at different locations in different databases may be linked to a single care plan); (6) a system that automatically learns about different views presented through user selection (such as automatically saving user preferences and user interface settings); and (7) algorithms that evaluate data (e.g., if facility A sends a patient to facility B, facility B evaluates work performed at facility A, such as an image acquired by facility A in mamma screening is evaluated by facility B) and identify patterns or trends. The above steps may be applicable or modified to be applicable to other types of cross institutional care plans.

In one aspect, the system and method may include using a rule engine, a care path implementation system, a databank, and input and output mechanisms. The care path may be implemented and programmed in an electronic formula or other algorithm. The fields in the formula may be linked to a database, either remote or local, such as a Microsoft SQL-database with a SQL (Structured Query Language) server. Other databases may be used. The system may be operable to add, delete, and/or select data (such as text and/or images) from data files. The system may offer a search mechanism, such as a search engine, operable to search remote databases. For instance, medical personnel at one facility may be able to remotely search a database stored at another facility involved with the performance of the care plan to gather information about the care plan, worksteps within the care plan previously or yet to be performed, and other information regarding the patient, including patient characteristics and other healthcare data provided to the patient unrelated to the care plan (such as medications previously or currently prescribed for the patient and past illnesses treated).

In one embodiment, the insurance policy number from the basic claims data is used as a search criterion among medical facilities. This may be beneficial for smaller groups of patients. Under a “Patient Status” menu, a user interface may provide access to and display check-up information of individual patients. In one aspect, an option to select a workstep called “Screening Mamma Carcinoma” via the user interface may be presented at various times/places, such as with a button entitled “Rescreening.” Another button may be operable to accept a user operation directing the performance and presentation of various evaluations of the data gathered, such as a button entitled “Evaluation for diagnostic and therapy decisions.” Other buttons may be entitled “Individual Therapy,” “Operation,” “Ambulance admission at the private physician after care,” and “Oncology,” and provide functionality for entering and displaying information for corresponding worksteps, including functionality described herein. Other buttons may provide other functionality and be associated with other worksteps.

The advantages of the present embodiments may include the ability of plugging a software module operable to provide the functionality discussed herein into any software application, such as Soarin Integrated Care™ (SIC) software from Siemens, and/or receiving patient data from a SIC or other database and saving the information in an external database as structured data. The present embodiments may provide for data mining databases associated with remote medical facilities, which is advantageous as current techniques may not permit data mining with SIC or other databases. Additionally, current techniques may store data in an unstructured manner that prohibits effectively and efficiently searching data stored among a plurality of facilities. On the other hand, the present embodiments may be used as a standalone application and efficiently search for and retrieve patient data from one or more external databases interconnected via a communications network.

In one aspect, the care plans may be accomplished employing one or more interactive software applications used by customer personnel at various customer locations. The care plans and associated software applications may assist medical personnel located at hospitals and other medical facilities to diagnose and treat patients. The care plans and software applications may support medical imaging techniques and devices.

### I. Exemplary Method of Cross Institutional Healthcare

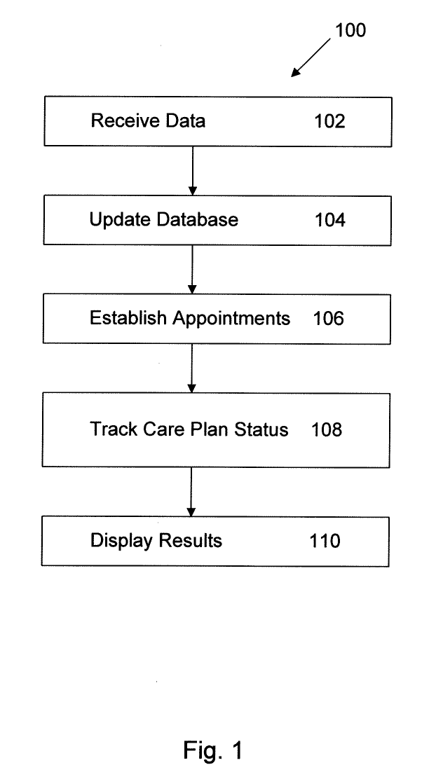

FIG. 1 illustrates an exemplary method of dynamically maintaining a virtual or machine readable representation of a care plan being administered to an individual patient up-to-date 100 such that the current status of the care plan and other workstep information may be remotely ascertained. The method 100 may include receiving data 102, updating a database 104, establishing appointments 106, tracking the care plan status 108, and displaying results 110. The method may include additional, fewer, or alternate actions.

The method 100 may include receiving data 102. The data may be locally received from a local machine. Alternatively, the data may be remotely received from a number of medical facilities over a communications network, such as the Internet or other wired or wireless network.

The data may be entered via a user interface by medical personnel at individual medical facilities or workstations. The data may include data related to a care plan involving a number of worksteps. For instance, the data may relate to patient information, performance and/or status of a workstep within the care plan, and appointment information. The data may include image data acquired during a workstep that a user attaches, downloads, or otherwise links to the care plan information. Alternatively, image data may be automatically linked to a virtual representation of the care plan accessible therefrom via a user interface. Other types of data may be received and/or linked to a virtual representation of the care plan. In one embodiment, the user interface is the user interface discussed herein below. Other user interfaces may be used.

The method 100 may include updating a database 104. The database may be updated using the data entered by medical personnel at one or more of the medical facilities. The database updated may be a local database located at an individual medical facility, or a remote database, which a plurality of medical facilities have access to, or a combination of both local and remote databases.

The data received may be used to update a virtual or machine readable representation of a care plan and/or associated worksteps within the care plan. The updated virtual representation may then be stored in the database as a manner of updating the database 104. Other patient information received also may be stored in the database. The data stored may be stored in a known or after developed structured format such that the updated database is searchable via known searching techniques and rules, such as by entering search terms.

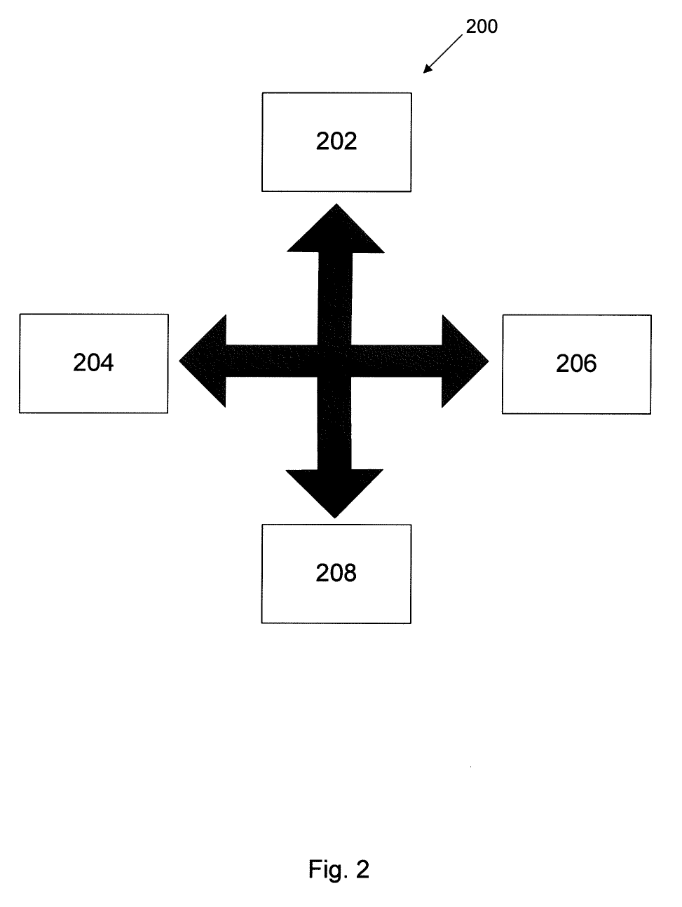

FIG. 2 illustrates an exemplary interconnected network 200. The interconnected network 200 may connect a plurality of medical facilities. The network 200 may include integrating access to a Soarian Integrated Care or other application 202, a care plan implementation 204, a database 206, and medical rules 208. The network may include additional, fewer, or alternate components. In one aspect, the network 200 implements a care plan associated with the detection and treatment of breast cancer. Other care plans may be implemented.

The network 200 may include local or remote access to one or more Soarian Integrated Care or other software solutions 202. Personnel at remote medical facilities may remotely access Soarian™ or other medical applications that facilitate the treatment and diagnosis of patients.

The network 202 may include a local care plan implementation 204. The local care plan implementation 204 may be tailored for individual medical facilities to account for the specific resources, such as equipment and personnel, available. The local care plan implementation 204 may be a software application that facilitates a care plan of a patient. The local care plan implementation 204 may have a dedicated user interface or implement equipment settings specific to a medical facility.

The network 206 may be interconnected with one or more databases 206. A database may be local or physically located at a medical facility. Alternatively or additionally, one medical facility may access databases located a central location and/or other medical facilities. All of the databases may store medical data in a structured manner such that the medical data is searchable. Each interconnected medical facility may access and retrieve medical files, patient information, and other data stored in the databases of other medical facilities that are also involved with administering the care plan to the patient.

The network 200 may have associated medical rules 208. The medical rules 208 may be based upon or define clinical pathways, customer specifications or requirements, and other guidelines. Alternate rules may be used. The rules may facilitate searching each of the interconnected databases such that data mining of medical data collected and stored within a database at one medical facility may be remotely searchable from other interconnected facilities also involved with the performance of the care plan.

Referring back to FIG. 1, the method 100 may include establishing appointments 106. Times and dates for future appointments may be entered via a user interface. Other information regarding the appointments, such as specific instructions and recommendations, may be entered. The appointment information may be saved in a database. After which, the status of the appointments may be tracked.

Notes and instructions regarding an appointment may be entered and subsequently accessed via the user interface. After an appointment occurs, the results and subsequent plan for further treatment may be summarized and entered via the user interface for storage within a database. The user interface permits medical personnel located at different and remote locations to all have access to the appointment schedule and results thereof of the patient/care plan.

The method 100 may include tracking the current status of a care plan of a patient 108. As noted above, after an appointment, information regarding the patient and/or treatment provided during the appointment may be entered and saved to a database. For example, information regarding each workstep to be performed within the care plan during the appointment may be stored in the database and accessed for visual reproduction via the user interface.

The method 100 may include displaying the results generated 110. A virtual or machine readable representation of the care plan or an overview thereof may be stored in one or more databases. The representation of the care plan may be remotely and/or locally accessed at each medical facility interconnected with the network. As a result, the computer representation of the care plan may be reproduced at each medical facility such that the current status of the care plan and information regarding the performance of previous worksteps may be textually, graphically, audibly, and/or pictorial displayed.

A care plan may be a “best practice” workflow, or a workstep a best practice workstep, that accounts for individual patient characteristics, such as sex, age, diseases, past and current illnesses, weight, height, allergies, symptoms, religion, race, ethnicity, medical history, and other characteristics of the patient. In one embodiment, the best practice care plan/workstep may account for the geographical region or location of the customer. For example, a hospital in a certain country may treat mostly patients of a specific race, ethnicity, or other characteristic.

A workstep of the care plan may be certified by mapping the clinical processes to established clinical guidelines and/or verified by experienced physicians. A workstep within the care plan may have an associated machine readable form of a virtual written description, graphical depiction, table, text, article, flowchart, or other virtual or machine readable representation of the best way of performing that workflow that is displayable via the user interface. For example, a graphic, table, or other visual representation may be presentable to the user that displays the process steps (such as a graphic depiction of the workstep, along with corresponding textual and/or audio information) of the implemented process and the corresponding clinical guideline.

The method 100 may include displaying results of evaluations performed via a processor on the data collected and received from a number of medical facilities. The data may be analyzed to determine and present, such as a via table or graph, the quality of performance exhibited by medical facilities and specialists. Medical facilities and specialists may be ranked relative to one another based upon a number of factors. For instance, the data may be automatically evaluated determine cost, quality of care, patient satisfaction, timeliness, duration of patient stay, success rate, and other factors.

### II. Exemplary User Interface

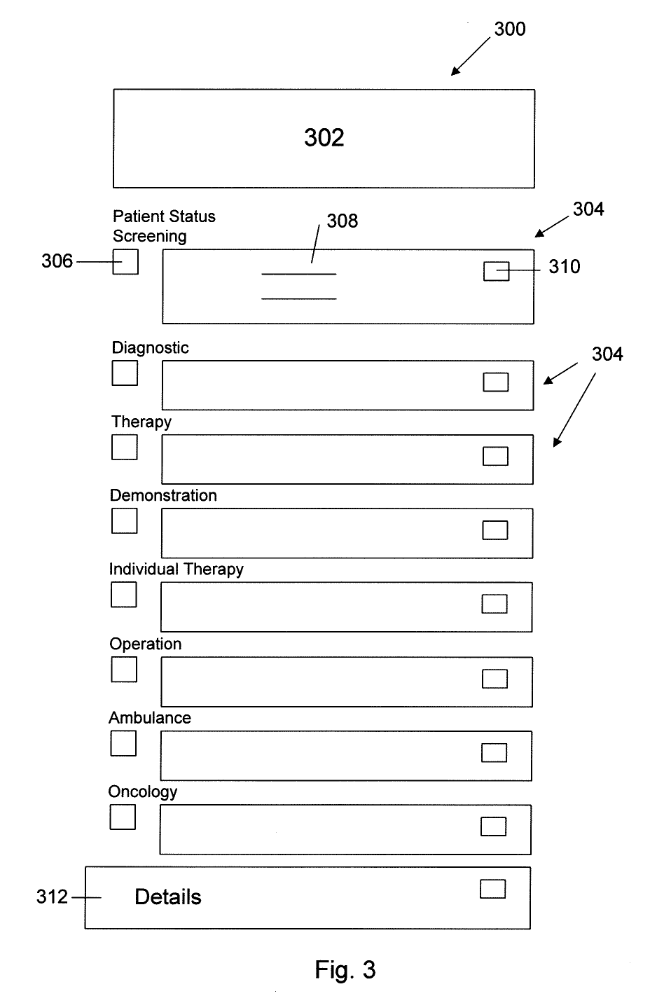

FIG. 3 illustrates an exemplary user interface 300 for dynamically maintaining a medical care plan up-to-date and sharing information regarding the care plan and associated worksteps among medical institutions performing the care plan. The user interface 300 may include a master data section 302, workstep sections 304, status boxes 306, text display 308, input buttons 310, and a details section 312. The user interface may include additional, fewer, or alternate components.

The user interface 300 may include a master data section 302. The master data section 302 may summarize characteristics of the patient. The master data section 302 may be part of a window or its own dedicated window.

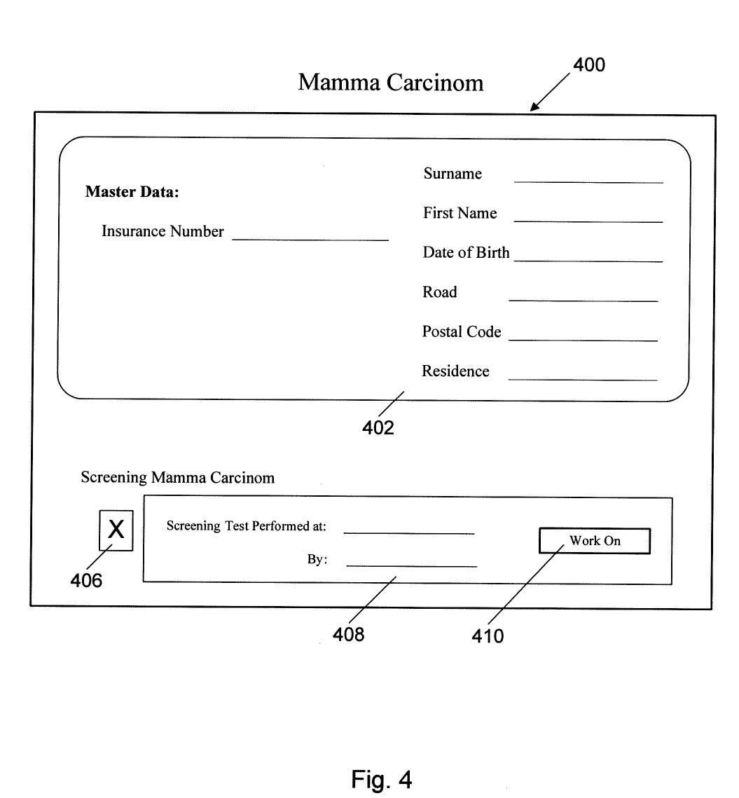

FIG. 4 illustrates an exemplary portion of a user interface 400. As shown, the master data 402 may include data related to the patients' health insurance or identification number, surname, first name, date of birth, and address (road, postal code, residence/country). Other master data 402 may be used. For example, master data detailing patient characteristics, such as age, sex, height, weight, illness, and other patient information may be displayed.

Referring back to FIG. 3, the user interface 300 may include a number of workstep sections 304. In the example show, the worksteps that define the current patient status include worksteps directed toward patient screening, diagnostics, therapy, demonstration, individual therapy, operation, ambulance care, and oncology. Other worksteps may be used. For instance, in-patient and out-patient care worksteps may be illustrated.

A status box 306 may be associated with each workstep box 304. The status box 306 associated with a workstep 304 may be marked with an “X” if that workstep is completed. Otherwise the status box 306 may be blank. As a result, a current status with respect to the completed, as well as outstanding, worksteps within the care plan may be readily ascertained. Additionally or alternatively, the status of worksteps may be colored coded. A workstep 304 may have a green background if completed, yellow background if partially completed, and red if completely outstanding. Other coloring schemes may be used.

Each workstep box 304 may display textual information 308 associated with the workstep. Each workstep box 304 may have one or more input buttons 310 for accepting instructions or other input operations from a user. An input operation performed on the buttons 310, such as via a mouse, keyboard, or touch screen, may result in further information about the workstep being displayed. For instance, the results of the workstep may be displayed if the workstep has already been performed. On the other hand, if the workstep is yet to be performed, instructions or other recommendations may be displayed. Alternatively, a best practice method of performing the workstep may be textually and/or visually displayed.

As shown in FIG. 4, the user interface 400 for a workstep related to screening mamma carcinoma may include a status box 406 that indicates whether the workstep has been performed or not. In one aspect, a displayed “X” may indicate that the workstep has been completed. The workstep information may include text information 408, such as information detailing who (i.e., which medical facility and/or specialist) performed the workstep, and when and where it was performed.

The workstep information may have an input button 410, such as the “work on” button shown. By performing an input operation, such as a mouse click, on the input button 410, a user performing the workstep may be presented with another screen that permits the entry of detailed information regarding the performance of the workstep. The detailed information may be saved to a local or remote database. Subsequently, medical personnel at the same or other medical facilities may be able to access and view the information entered by the person that performed the workstep.

The user interface 300 may have a details box 312. The details box 312 may be associated with displaying or summarizing the results of evaluations of medical facility and/or personnel performance. For example, the results of evaluations or other analysis may be summarized, such as in table or chart. The results may be color coded, such as green for best performance, and red for worst.

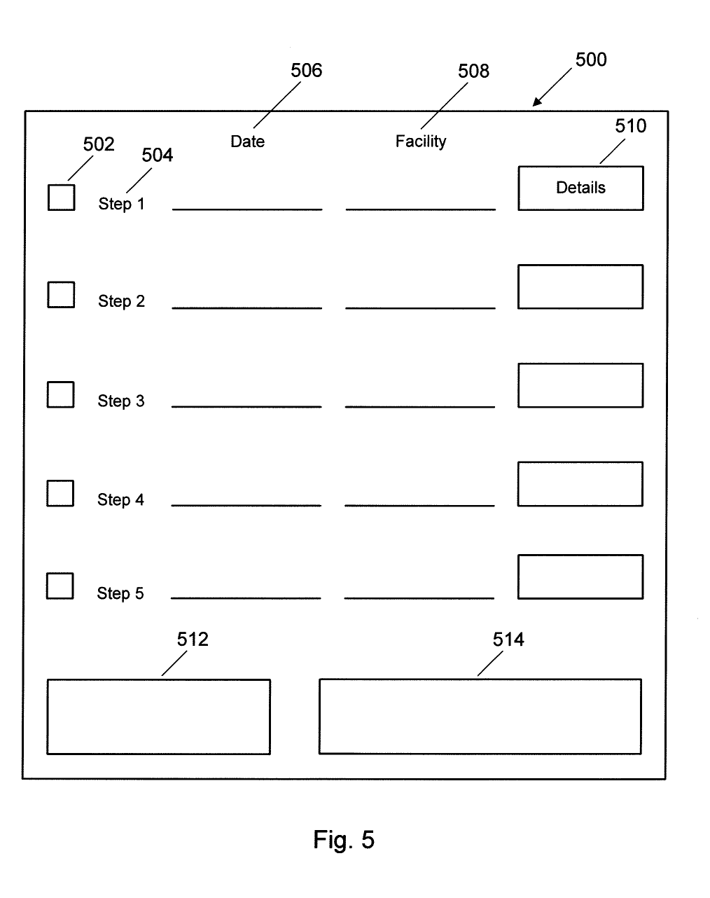

FIG. 5 illustrates another exemplary user interface 500. The user interface 500 may include status boxes 502, representations of a number of worksteps 504, date information 506, facility information 508, input buttons 510, and other input buttons 512, 514. The user interface 500 may be separate from or part of a screen associated with the display of the user interface 300 of FIG. 3. For instance, the user interface screen section 500 of FIG. 5 may be displayed under the user interface screen section 300 of FIG. 3 in a single display. The user interface 500 may include additional, fewer, or alternate components.

The status boxes 502 may indicate whether or not a workstep 504 has been completed. The date 506 and facility 508 at which a workstep is scheduled to be performed or has already been performed at may be identified. For instance, a user may enter appointment information associated with the workstep 504, such as date and facility. The data entered may be saved to a database, such as via an input operation performed on button 512. Button 514 may provide access to another screen for the entering of notes and instructions regarding one or more worksteps.

The details button 510 may provide access to a screen that displays textual, graphical, audio, and/or video instructions about a workstep to be performed. Alternatively, the button 510 may provide access to a screen that permits a user to enter data regarding the result of a workstep actually performed. For instance, the results of a workstep may textually summarized by a user and saved to a local or remote database. Or images acquired during the workstep may be linked to a corresponding results screen displayed via an operation being performed on the details button 510.

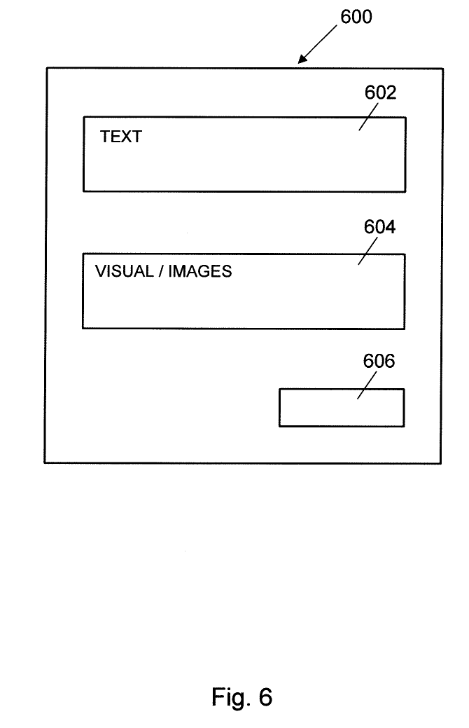

FIG. 6 illustrates an exemplary details screen 600. As mentioned directly above, the user may access textual information regarding the results of a workstep and/or actual medical images acquired during the workstep. Medical personnel that have recently completed the workstep may summarize the results of the workstep by entering text in the text box 602. Additionally, images of a patient acquired during the workstep may be linked to the details screen 600 for display in the images box 604. A number of images may be displayed in the images box 604 and be scrollable. An input button 606 may allow for data entered to be saved to a database for subsequent reproduction by other medical personnel. In one embodiment, the text box 602 displays information regarding a workstep related to the treatment of breast cancer and the images box 604 displays internal medical images of the patient's breasts acquired during the workstep.

The user interface may be modifiable by user. For instance, a user may be able to add additional patient fields within the portions of the user interface associated with individual worksteps. The user also may add sections for new worksteps to be included within a care plan. Alternate customizations to the user interface may be made.

In sum, the user interface provides a manner of cross institutional transfer of information. The user interface provides a mechanism for tracking the screening of patients and an overview of past care that the patient has received, and the efficient transfer of information among a plurality of medical facilities. The user interface may provide a manner of communicating the care plan for a patient among a number of facilities and ensure quality is maintained. Maintaining quality may be facilitated by the aspect of the user interface that may permit access to best practice care plans and individual worksteps. In one embodiment, screening for breast cancer is performed according to a best practice workflow and/or standardized guidelines, such that the chance of early detection of breast cancer may be enhanced.

Additionally, by tracking the status of appointments and the care plan, costs associated with healthcare may be reduced. Redundant medical care may be eliminated, as worksteps already performed may be easily ascertained via an overview of the care plan being displayed. Additionally, exams, procedures, and other worksteps that remain to be completed may be readily ascertained without undue delay and promptly performed without any need to directly contact medical personnel at other facilities, such as via telephone.

### III. Exemplary Data Processing System

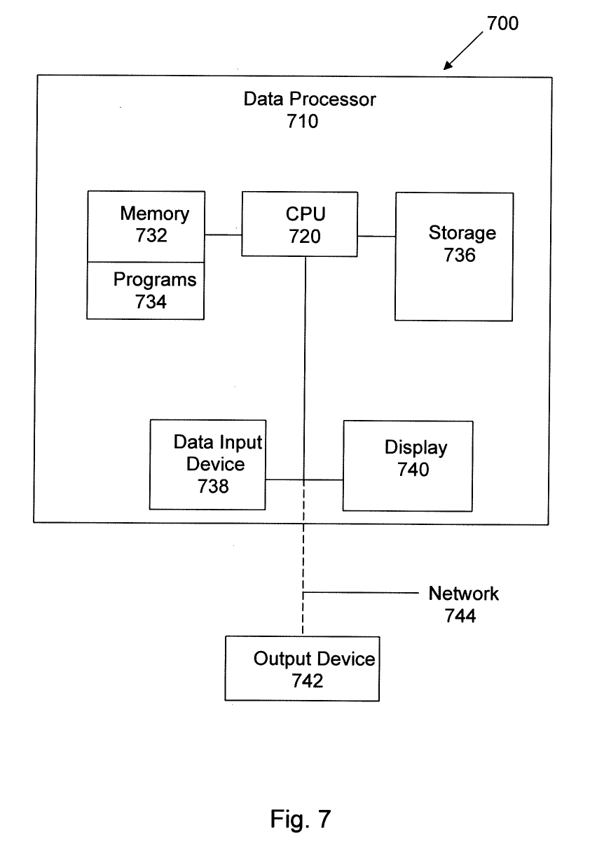

FIG. 7 illustrates an exemplary data processor 710 configured or adapted to provide the functionality for dynamically maintaining a care plan performed at a number of dispersed medical facilities up-to-date. The data processor 710 may be located at a central location. The data processor may include a central processing unit (CPU) 720, a memory 732, a storage device 736, a data input device 738, and a display 740. The processor 710 also may have an external output device 742, which may be a display, a monitor, a printer or a communications port. The processor 710 may be a personal computer, work station, PACS station, or other medical imaging system. The processor 710 may be interconnected to a network 744, such as an intranet, the Internet, or an intranet connected to the Internet. The processor 710 may be interconnected to a customer system or a remote location via the network 744. The data processor 710 is provided for descriptive purposes and is not intended to limit the scope of the present system. The processor may have additional, fewer, or alternate components.

A program 734 may reside on the memory 732 and include one or more sequences of executable code or coded instructions that are executed by the CPU 720. The program 734 may be loaded into the memory 732 from the storage device 736. The CPU 720 may execute one or more sequences of instructions of the program 734 to process data. Data may be input to the data processor 710 with the data input device 738 and/or received from the network 744. The program 734 may interface with the data input device 738 and/or the network 744 for the input of data. Data processed by the data processor 710 may be provided as an output to the display 740, the external output device 742, the network 744, and/or stored in a database.

The program 734 and other data may be stored on or read from a machine-readable medium, including secondary storage devices such as hard disks, floppy disks, CD-ROMS, and DVDs; electromagnetic signals; or other forms of machine readable medium, either currently known or later developed. The program 734, memory 732, and other data may comprise and store a database of files and data associated with a virtual or machine readable representation of a care plan, other patient data, best practice workflows, image data, and other medical data. The database may be organized such that the information regarding worksteps within the care plan and associated data may be remotely searchable and retrievable via a search engine operating over a network, such as the network 744.

In one embodiment, the data processor 710 may be operable to accept information and update the status of the care plan to account for worksteps performed at one or more medical facilities. The updated care plan also may be stored within a database or other memory unit. A virtual care plan (in digital data or machine readable form) may be received by the data processor 710 from the database, data input device 738, the network 744, or another input device. After which, the data processor 710 may revise the care plan to create a dynamically updated virtual care plan (in digital data or machine readable form) that may be stored in the memory 732, the storage device 736, or other storage unit.

Workstep data detailing the performance of specific worksteps within the care plan, such as textual information, physician notes and/or instructions to other physicians, prescriptions, follow-up care instructions, appointments, and image data associated with images of the patient acquired via a medical imaging device during the workstep, may be received from a remote medical facility by the data processor 710 via the data input device 738, the network 744, or another input device. The data processor 710 may display and/or modify the virtual care plan using the data received.

The data processor 710 may integrate or otherwise combine workstep data received from a number of medical facilities regarding worksteps performed at each of the facilities. The data processor 710 may provide remote access to a best practice workstep via a user interface located at a distant medical facility. The best practice workstep may have corresponding text, audio, video, and/or graphical instructional information that is remotely reproducible. The integration of the data received from a number of medical institutions performing the care plan by the data processor 710 may be fully or partially automated.

The data processor 710 may compute various evaluations of the quality of performance exhibited by different medical facilities and/or medical personnel. The evaluations may be determined by analyzing data regarding the performance of a number of worksteps associated with a single type of care plan, the performance of any workstep associated with any type of care plan, or other data. The evaluations may summarize cost, man-hours, medicine, lab time, customer satisfaction, survival rate, hospital stay time, and other results related to care plans and/or the performance of related worksteps. The results of the evaluation may be visually depicted on a display.

The data processor 710 may accept search terms entered by a customer, such as patient identification number, and transfer data associated with the search terms to the remote medical facilities via the network 744, the output device 742, or other manner. Based upon the search terms and/or search logic and rules, a care plan of a specific patient may be retrieved from the database by the data processor 710.

An up-to-date care plan may be transferred to a medical facility via the network 744, output device 742, or other manner. The care plans transferred may be in the form of machine readable graphical and/or textual representations, executable versions of software applications, data to alter software applications installed at the customers locations, stand alone applications, modifications or revisions to pre-existing applications, or other forms.

### IV. Exemplary Clinical Workflows and Related Software Applications

The customer locations may be hospitals, clinics, or other medical facilities. The customer personnel may include doctors, nurses, and other medical personnel. The clinical care plans and associated software applications may assist the medical personnel with the diagnosis of medical conditions and the treatment of patients.

In one aspect, the care plan may relate to the integration of a clinical workflow across care settings. The care plan may be engineered to synchronize a number of processes and employ a user interface tailored to the needs of a customer. In one embodiment, the care plan may be implemented via an information technology (IT) solution, such as Siemens' Soarian Clinical Access™ that provides access to clinical repository data from Syngo™-enabled imaging workstations, and brings diagnostics and IT to a single workstation. Syngo™ is a medical imaging operating system and user interface that works with various imaging technology, while Soarian™ employs a browser enabled user interface modeled on Syngo™ and offers ease of navigation by giving all medical images, clinical, and financial data a common look and feel, and organizing everything into one logical, patient-centric view.

In another aspect, the care plan may relate to processing images illustrating an enhanced region of interest within a patient. For example, various types of contrast medium may be administered to a medical patient. While the contrast medium is traveling through or collected within a region of interest, a series of scans or images of the region of interest of the patient may be recorded for processing and display by the software applications. The enhanced region of interest may show the brain, the abdomen, the heart, the liver, a lung, a breast, the head, a limb or any other body area.

The expected enhancement data may be generated for one or more specific type of image processes that are used to produce the images or scans of the patient. In general, the types of imaging processes that may be used to produce patient images or scans of internal regions of interest include radiography, angioplasty, computerized tomography, ultrasound and magnetic resonance imaging (MRI). Additional types of imaging processes that may be used include perfusion and diffusion weighted MRI, cardiac computed tomography, computerized axial tomographic scan, electron-beam computed tomography, radionuclide imaging, radionuclide angiography, single photon emission computed tomography (SPECT), cardiac positron emission tomography (PET), digital cardiac angiography (DSA), and digital subtraction angiography (DSA). Alternate imaging processes may be used.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A method of facilitating cross institutional healthcare, the method comprising:
dynamically maintaining a virtual representation of an overview of a care plan for a patient up-to-date by integrating medical information regarding individual worksteps associated with the care plan via a processor, the individual worksteps being performed among a plurality of medical facilities; and
providing remote access to data associated with the virtual representation of the overview of the care plan over a communications network such that the virtual representation may be reproduced to display a current status of the care plan at a remote location.

2. The method of claim 1, the method comprising:
evaluating a quality of performance of the plurality of medical facilities and/or individual specialists by analyzing workstep data associated with a number of worksteps and/or care plans performed upon a plurality of patients; and
displaying the results.

3. The method of claim 1, wherein the medical information provides an overview of past care the patient has received and the current status indicates whether the individual worksteps have been completed and a time and place of a next scheduled appointment for the patient.

4. The method of claim 1, the method comprising remotely searching a database stored at a first medical facility from a second medical facility over the communications network to obtain information regarding other healthcare not related to the care plan provided to the patient at the first medical facility.

5. The method of claim 1, comprising sharing electronic information among the plurality of medical facilities regarding the patient by using the patient's health insurance identification number as a link between electronic files.

6. The method of claim 1, the method comprising:
transferring data regarding textual information and internal images of the patient associated with a performance of a workstep at a first medical facility over the communications network to a second medical facility; and
displaying the textual information and internal images at the second medical facility on a display.

7. The method of claim 1, wherein the care plan provides for the detection and treatment of breast cancer.

8. A method of facilitating cross institutional healthcare, the method comprises:
dynamically updating a virtual representation of a care plan for a patient using workstep data associated with a performance of a workstep within the care plan at a first medical institution; and
providing remote access to data associated with the dynamically updated virtual representation of the care plan over a communications network such that the dynamically updated virtual representation may be reproduced at a second medical institution to display information regarding the performance of the workstep within the care plan performed at the first medical institution.

9. The method of claim 8, the method comprising:
evaluating a quality of performance of a medical facility and/or individual specialist by analyzing data associated with similar care plans performed at the medical facility or by the individual specialist, respectively; and
presenting results of the evaluation on a display.

10. The method of claim 8, the method comprising:
providing remote access to a searchable database of medical information regarding information about the patient gathered by and stored by the first medical facility; and
remotely searching the searchable database from the second medical facility.

11. The method of claim 8, the method comprising:
setting up an appointment for the patient from the first medical facility by entering a date and place of the appointment via a user interface; and
remotely viewing the date and place of the appointment via a display at the second medical facility.

12. The method of claim 8, the method comprising:
remotely tracking a current status of the patient among a plurality of medical institutions; and
displaying a virtual representation of the current status within the dynamically updated virtual representation of the care plan at one or more of the plurality of medical institutions.

13. The method of claim 12, the method comprising:
displaying information detailing recommended performances of worksteps within the care plan at one or more of the plurality of medical institutions via a user interface.

14. The method of claim 8, wherein the care plan involves the use of a medical imaging device to acquire internal images of the patient.

15. The method of claim 8, wherein the care plan provides for the detection and treatment of mamma carcinoma tumors.

16. A data processing system for providing cross-institutional healthcare, the system comprising:
a data processor operable to:
(1) remotely receive data from a plurality of medical facilities regarding a single care plan for a patient over a communications network, the single care plan comprising a plurality of worksteps to be performed among the plurality of medical facilities;
(2) dynamically maintain a current status of the care plan for the patient up-to-date using the data received; and
(3) provide remote access to a machine readable representation of the up-to-date care plan over the communications network such that each of the plurality of medical facilities may locally reproduce the machine readable representation of the up-to-date care plan.

17. The data processing system of claim 16, wherein the processor is operable to evaluate a quality of performance of a medical facility or individual specialist by analyzing data associated with similar care plans performed upon a plurality of patients by the medical facility or individual specialist, respectively.

18. The data processing system of claim 16, wherein the processor is operable to dynamically maintain the care plan up-to-date by using an identification number associated with the patient as an electronic link between files stored among the plurality of medical institutions.

19. The data processing system of claim 16, wherein the processor is operable to remotely mine data stored at one medical facility from another medical facility.

20. The data processing system of claim 16, wherein the processor is operable to present textual information related to and images acquired during a past performance of a workstep within the care plan already performed at a different location.

21. The data processing system of claim 16, wherein the processor is operable to present instructions, on a display, regarding a preferred performance of a workstep within the care plan that is yet to be performed.

22. A computer-readable medium having instructions executable on a computer stored thereon, the instructions comprising:
dynamically updating a virtual representation of a care plan for a patient using first workstep data regarding the performance of a first workstep associated with the care plan at a first medical facility; and
providing remote access to the dynamically updated virtual representation of the care plan such that the dynamically updated virtual representation of the care plan may be reproduced to display a current status of the care plan at a second medical facility.

23. The computer-readable medium of claim 22, the instructions comprising:
accepting input operations entered via a user interface; and
accessing information regarding a performance of a workstep within the care plan previously performed at a remote location.

24. The computer-readable medium of claim 22, the instructions comprising accepting textual information regarding a performance of a workstep and storing image data associated with the performance of the workstep for subsequent reproduction at a remote location, the image data being acquired via a medical imaging device.

25. The computer-readable medium of claim 22, the instructions comprising:
evaluating a quality of performance of a medical facility and/or specialist that perform care plans similar to the care plan; and
displaying the results of the evaluation.
